(19) United States
(12) Patent Application Publication
(10) Pub. No.: US 2010/0306757 A1
(43) Pub. Date: Dec. 2, 2010

(54) DETERMINING COMPATIBILITY AMONG SERVICE VERSIONS

(76) Inventors: Karin BECKER, Porto Alegre (RS); Andre Lopes, Porto Alegre (RS); Sharad Singhal, Belmont, CA (US); James Pruyne, Naperville, IL (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/474,114

(22) Filed: May 28, 2009

(51) Int. Cl. G06F 9/44

(52) U.S. Cl. 717/170

(57) ABSTRACT

A method comprises receiving, by a processor, a description of a later version of a service model and determining, by the processor, backward compatibility of the description of the later version of the service model with a description of a previous version of the service model. Each service model comprises one or more versionable types and each versionable type has an associated description.

### BACKGROUND

Service-Oriented Architectures (SOA) allows the composition and coordination of loosely coupled services. SOA enables independent development of services and client applications by disparate teams, each one with its own delivery and maintenance schedule. Because the development lifecycles of services and clients are de-coupled, multiple versions of services are maintained to continue supporting older clients. For example, as a service is upgraded, it should continue to support older client applications that were designed before the upgrade, while meeting requirements of new client applications designed following the upgrade of the service. Coordination among multiple versions of a service is difficult.

### BRIEF DESCRIPTION OF THE DRAWINGS

For a detailed description of exemplary embodiments of the invention, reference will now be made to the accompanying drawings in which:

FIG. 1 shows a network in which clients can access service version in accordance with various embodiments;

FIG. 2 shows a model framework for describing the services in accordance with various embodiments;

FIG. 3 shows an embodiment of a computing system in accordance with various embodiments;

FIG. 4 shows a method in accordance with various embodiments;

FIG. 5 provides an example of the use of the techniques described herein in accordance with various embodiments; and

FIG. 6 provides a system in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In accordance with various embodiments, compatibility between related versions of a service is automatically assessed. In the embodiments described herein, compatibility is not inferred from version number conventions, nor are changes restricted between service versions to avoid incompatibility. The compatibility assessment techniques described herein are based on a version framework that allows service descriptions to evolve in different granularity levels, by considering a loose-dependency between the services and the elements used to describe them.

The term “service version” (or just “version”) refers to a particular implementation of a service. From a client's standpoint, a service version is the “contract” established by the interface of the service, and consequently, to the functionality a service delivers and the data types which the service exposes within the interface.

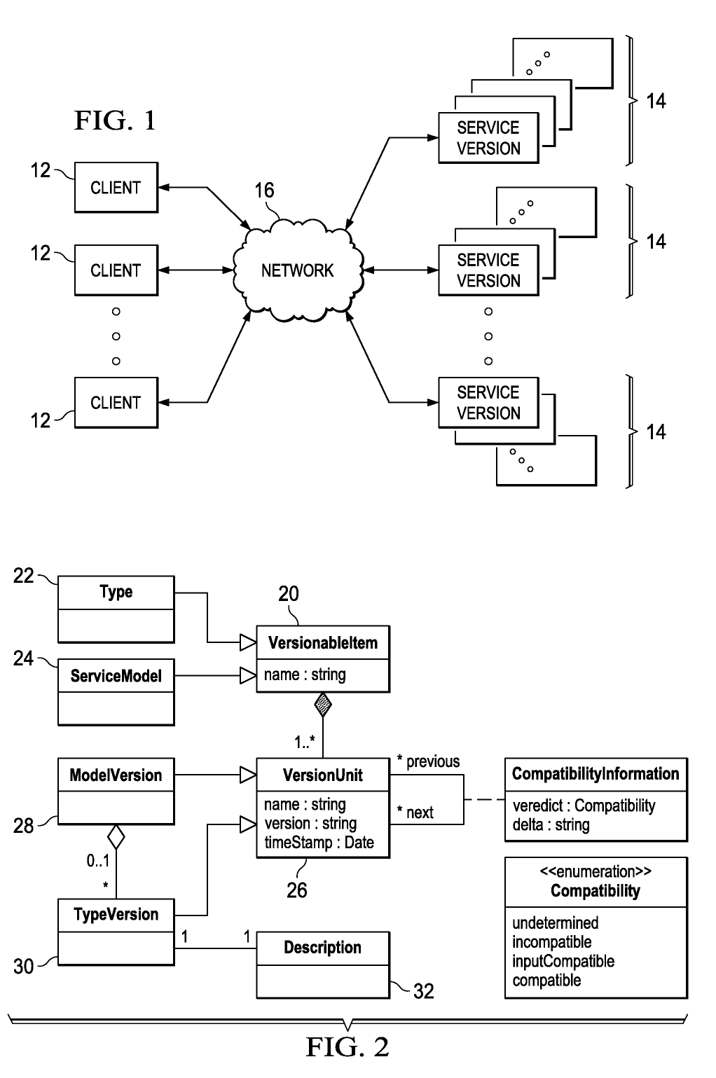

FIG. 1 illustrates a system in which one or more clients 12 access one or more services 14 via a network 16. Each client 12 may represent an application or a computer on which a client application executes. Each service is implemented as an application that runs on a computer as well. The network transfers messages from each client 12 to a service 14 to which that client desires access. A client 12 may access more than one service 14 at a time. Response messages from the services 14 pass back through the network to the appropriate client 12.

Over time, a service may evolve by the designers of that service. Moreover, an updated version of the service may be released for use by the clients 12. As such, one or more or all of the services 14 shown in FIG. 1 may comprise more than one version of that particular service.

A “type” describes part of the service functionality or properties of exchanged data. Integration helps to ensure success of an SOA, and therefore, it is desirable that types are reused (or shared) as much as possible across services. This is particularly important in the context of service composition, where message content is transparently forwarded in the context of composed services. Thus, flexibility in service description and integration is achieved by considering a loose relationship between types and the service models they help describe. To achieve such independence, types can evolve independently from service models.

FIG. 2 depicts an illustrative version framework for addressing compatibility. The framework of FIG. 2 shows that each service can be represented by one or more versionable items 20. Each versionable item is either a “type” 22 or a “servicemodel” 24. That is, there are two kinds of versionable items—type versionable items 22 and service model versionable items 24. FIG. 2 also depicts that each versionable item, be it a type 22 or a service model 24, contains a “versionunit” 26. Each versionunit 26 in at least some embodiments includes a name, a version, and time stamp. The name and version may comprise strings and the timestamp may be a date. There are two kinds of versionunits—model versions 28 and type versions 30. Each type version 28 is associated with a description 32. The collective information that defines the service provides the description of that service version.

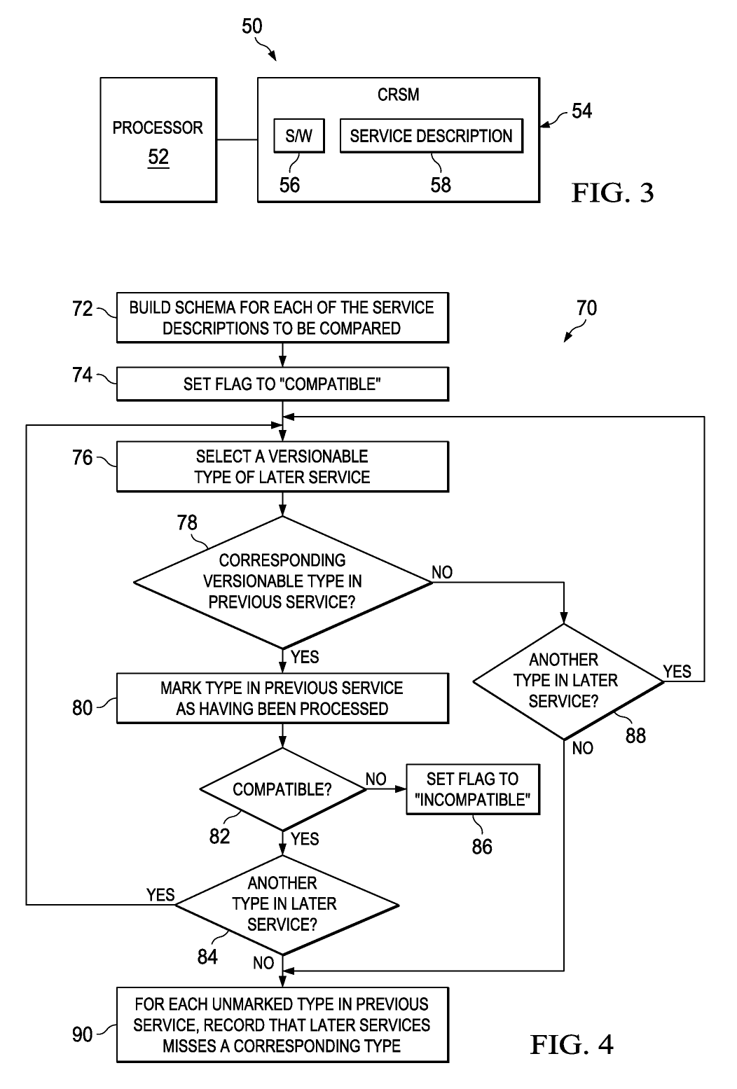

In accordance with various embodiments, a later version of a service is automatically (i.e., by a computer and not by a human) compared against one or more all prior versions of that service to determine whether the later version is backward compatible with the prior version(s). FIG. 3 shows a computer system 50 for performing the backward compatibility assessment. As shown, system 50 comprises a processor 52 coupled to a computer-readable storage medium (CRSM). The CRSM 54 may be contained within the same chassis as the processor 52 or may be separately housed and accessible by the processor. The CRSM 54 comprises volatile memory (e.g., random access memory), non-volatile storage (e.g., hard disk drive, read-only memory, Flash storage, etc.), or combinations thereof. The backward compatibility assessment may be performed, for example, upon the introduction of a new (later) version of a particular service.

As shown in the example of FIG. 3, the CRSM 54 stores software 54 and service descriptions 58. The software 58 is executed by the processor 52 and performs some or all of the functionality described herein. The service descriptions comprise the information about each service and service version such as the framework information explained above with regard to FIG. 2. The software obtains the descriptions of two versions of the same service and compares those versions to determine if the later version is backward compatible with the earlier version. If there are three or more versions of the same service, the software, in some embodiments, determines whether the latest version is compatible with each of the earlier versions.

In accordance with various embodiments, a two-phase compatibility assessment process is performed—type-based compatibility and model-based compatibility. In the assessment of type compatibility, not all contextual information for a final decision is necessarily available: the versions of the types to which a given type is related may not be known in advance, nor are the specific dependencies with other types within a model. Model-based compatibility assessment complements type-level assessment, by putting type versions in the context of the model version and thus defines the scope of their relationships.

Compatible changes that can be applied to types are summarized in Table 1. That is, a type in a later service version is compatible with an earlier version of the service if any of the entries in Table I applies. It is assumed that types are described by classes, and that attributes and operations are defined within those classes. Relationships between classes are declared using associations. Changes on types used as parameters within operations must be viewed from two perspectives, as represented by their role as input or output parameter. Thus type compatibility is sensitive to the context within which the type is used and depends on the overall schema. The column labeled Output Restriction in Table 1 highlights the cases that are backward compatible only if they do not appear as an output of some operation (perhaps defined in some other type). Thus from a client point of view, in at least some embodiments the results of the operation should conform to a type that guarantees all expected information, functionality and constraints. From a service point of view, constraints can be relaxed as long as the service implementation guarantees it can still provide the same functionality.

TABLE 1
Type level backward compatible changes

| Update | Type | | Output |
|---|---|---|---|
| Operation | Element | Description | Restriction |
| add | Operation | Add a new operation | |
| change signature: | Operation | Change lower bound | |
| input parameter | | cardinality from | |
| | | mandatory to optional | |
| change signature: | Operation | Change parameter | |
| input parameter | | class to superclass | |
| | | (immediate or not) | |
| Add | Attribute | Add new attribute | |
| | | where lower bound | |
| | | cardinality is optional | |
| Change | Attribute, | Change cardinality | Yes |
| | association | lower bound from | |
| | participant | mandatory to optional | |
| Change | Attribute, | Change cardinality | Yes |
| | association | upper bound from (1) | |
| | participant | to (*) | |
| Change | Attribute, | Change referenced | yes |
| | association | class to a superclass | |
| | participant | (immediate or not) | |

Table I shows that, for a later type version, an operation or attribute can be added with respect to the earlier version of that type and the later type version is still considered compatible with the earlier version. Further, operations and attributes can be changed and still be considered compatible. Specifically, an operation for which an input parameter signature has changed a lower bound cardinality from mandatory to optional is considered a compatible operation change. Similarly, an operation for which an input parameter signature has changed a parameter class to a superclass is considered a compatible operation change. Some changes in attributes are also listed and considered to be compatible changes. Changing the cardinality lower bound from mandatory to optional, changing the cardinality upper bound from one to any number, and changing the referenced class to a superclass are also considered compatible changes, but the output is restricted. A class defines a set of attributes and operations that can perform on a logical entity (an “object”). A superclass refers to a starting point for defining new objects with attributes and operations when it is desired to extent or specialize the superclass by creating a new class.

It should also be noted that compatibility is not restricted to the syntactical properties of types. Semantics can be conveyed by informal notes or formal constraints (e.g., as represented by UML metaclasses).

Applying the rules of Table I, given two type versions 30—an earlier TypeVersion t and later Typeversion v, and delta(t, v) is not empty (i.e., there are differences between the two type versions), the compatibility of t with regard to v is:
Incompatible: if at least one operation o in delta(t,v) is not listed in Table 1;
Input Compatible: if all operations o in delta(t,v) are listed in Table 1, and at least one of them is output restricted.
Compatible: if all operations o in delta(t,v) are listed in Table 1, and none of them is output restricted.
   Here delta(t, v) represents the changes (e.g., additions, removals, modifications) that are necessary to change TypeVersion t into TypeVersion v.

Model versions are sets of versioned types, and their compatibility is assessed in terms of update, addition and removal of types as defined above. The removal of types from an earlier version of a service to later version renders the later service version to be incompatible because the older client (which understands the interfaces to the older service version) will expect to see the type that no longer exists in the later service version. However, the addition and update of types usually require contextual information about how the underlying type versions are related in the model to assess their compatibility. In addition to type version compatibility, the following relationships between type versions are of relevance for model compatibility assessment: sub-classing, dependencies established by strongly typed arguments or attributes, and participation in associations. Different descriptions related to these sets of type versions result in different model schemas. Compatible changes between an earlier and a later service model are listed in Table 2, and all others are regarded as incompatible.

TABLE 2
Schema level backward compatible changes

| | Model | | Output |
|---|---|---|---|
| Operation | Element | Description | restriction |
| Add | Class | Add a type t in new-model | |
| Update | Class, | Replace version v of type t in | Yes |
| | Association | previous-model by a compatible | |
| | | version v′ of t in new-model | |
| Update | Class, | Replace version v of type t in | |
| | Association | previous-model by an | |
| | | input Compatible version v′ of t in | |
| | | new-model | |
| Add | Association | Add type t in new-model, such | |
| | | that if a participant class in the | |
| | | description of t refers to a type u | |
| | | contained previous-schema, the | |
| | | lower-bound cardinality | |
| | | constraint must be optional | |

Given two model versions x and y, where y is a later version compared to x and delta(x, y) is not empty, the compatibility of y with regard to x is:
Undetermined: if at least one operation o in delta(x, y) replaces a version v of a type t by a version v′ of the same type, where v′<v;
Incompatible: if there is at least one operation in o in delta(x, y) that is not listed Table 2, and this operation does not qualify the model's compatibility as Undetermined;
Compatible: if all operations o in delta(x, y) are listed in Table 2.

FIG. 4 shows an illustrative method 70 of assessing model-level compatibility. The method may be performed by processor 52 of FIG. 3. The method is performed by, for example, processor 52 (FIG. 3). At 72, the process builds the schema structure for each model version to be compared. This step involves examining each type in both service models, and extracting the information necessary in the schema (FIG. 2) from the type description. To create this structure all descriptions associated with the type versions included into each model are considered, and schema components are created that are related to each other through the relationships required for investigating compatibility, i.e., superclass, subclass, associations in which they participate, dependencies as operation parameters and strongly typed attributes. In addition, the process of building the schema structures evaluates if a type is used to strongly type an output argument anywhere in the schema.

At 72, a flag is set to “compatible.” Throughout the process depicted in FIG. 4, if an incompatibility is detected, the flag is then set to “incompatible.” Thus, compatibility is assumed until proven otherwise.

At 76, a versionable type in the later service is selected for analysis. At 78, the process determines whether a versionable type corresponding to the type selected in 76 can be found in the earlier model. If not, then at 88, it is determined whether an additional type in the later service remains to be analyzed and, if such a type exists, the process loops back to 76 to select that type for further analysis.

If, at 78, a corresponding type in the earlier service does exist, then at 80, the particular type is marked as having been processed. At 82, the method comprises determining whether the types in the later and earlier service versions are compatible (e.g., by application of the rules of Table 2). If the types are not compatible, then at 86, the flag is set to “incompatible.” If, however, the types are compatible, the flag remains set at “compatible,” and it is determined (at 84) whether another type exists in the later service version for analysis. If an additional type exists for further analysis, then the process loops back to step 76 in which the additional type is selected for analysis as described above. If no more types exists for analysis in the later service version (as determined at 84 or 88), then process moves on to step 90. At 90, for each unmarked type in the previous (earlier) service, the method records that the later service is missing a corresponding type. The method of FIG. 4 processes all types in both models to produce a compatibility verdict and a complete explanation of the differences

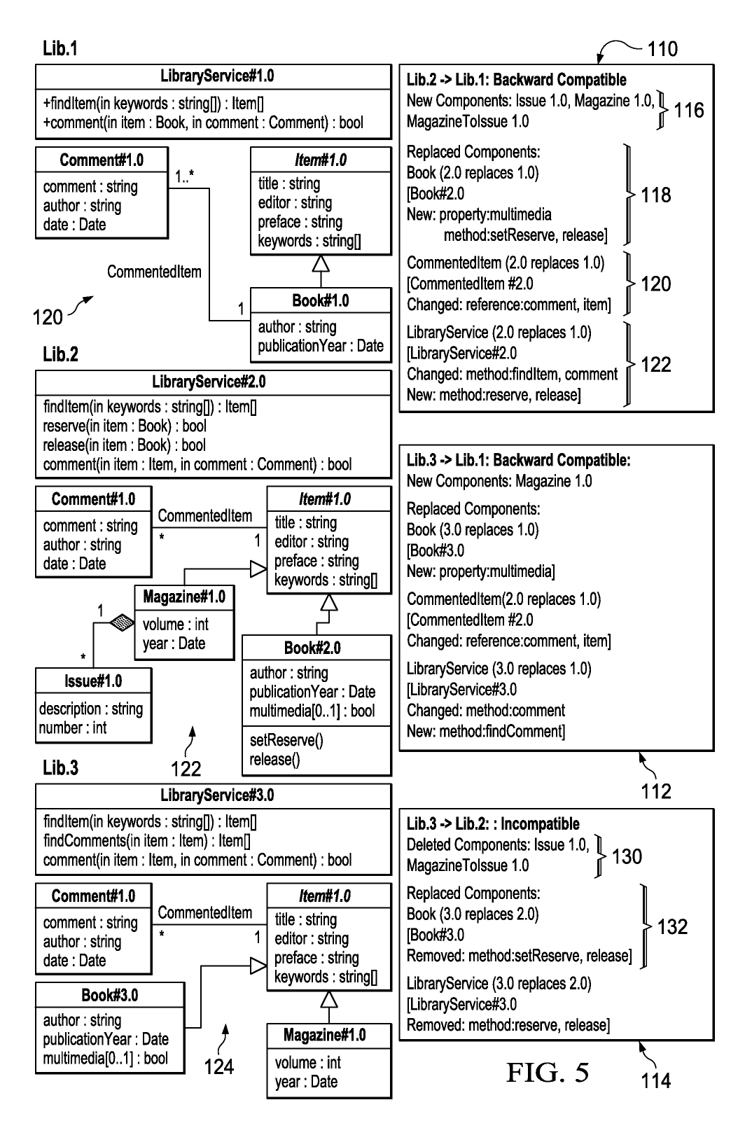

FIG. 5 provides an illustrative example of the techniques described above. FIG. 5 illustrates three version of a library service (Lib). The three service versions are Lib.1, Lib.2, and Lib.3. Lib.3 is a more updated version of the library service than Lib.2 and similarly, Lib.2 is more recent than Lib.1. Lib.1 is depicted at 120, and Lib.2 and Lib.3 are depicted at 122 and 124, respectively.

Lib.1 contains four type versionable units labeled as LibraryService#1.0, Item#1.0, Book#1.0, and Comment#1.0. Lib.2 contains six versionable units labeled as LibraryService#2.0, Item#1.0, Book#2.0, Magazine#1.0, Issue#1.0, and Comment#1.0. Lib.3 contains five type versionable units labeled as LibraryService#3.0, Item#1.0, Book#3.0, Magazine#1.0, and Comment#1.0

In Lib.1, the service provides operations to find any library item based on keywords, and to provide comments on a book, as indicated by the relationship Commenteditem connecting Comment#1.0 to Book#1.0.

In Lib.2, the service is able to provide comments on any library item indicated by the relationship Commenteditem between Comment#1.0 and Item#1.0. As such, the input argument of operation Comment is generalized. Another incremental feature in Lib.2 (compared to Lib.1) is the ability to reserve books, as well as the explicit control of Magazines and their respecti2e Issues. The type Book#2.0 contains the same attributes (author and publication year) as Book#1.0 but adds an additional attribute (multimedia) and two new operations (reserve and release).

In Lib.3, the service provider decides that these new features do not pay off (e.g., they are not used or they are too expensive to maintain). Consequently, operations reserve and release are removed from the Book type as well as the LibraryService. Further, Issue control is also removed (i.e., the type Issue is not present in Lib.3).

The right-hand side of FIG. 5, at boxes 110, 112, and 114, shows the result of the service version backward compatibility assessment comparing Lib.3 to Lib.2, Lib.3 to Lib.1, and Lib.2 to Lib.1. It is determined that Lib.2 is backward compatible with Lib.1 and that Lib.3 is backward compatible with Lib.1. However, Lib.3 is determined to be incompatible with regard to Lib.2. The remarks in each box 110-114 provides the results of the comparison. For example, in box 110 at 116, it is noted that new types Issue#1.0 and Magazine#1.0 are present in Lib. 2 (with respect to Lib.1), and that the Issue is linked to Magazine. Further, at 118 it is noted that Book#2.0 replaces Book#1.0 with Book#2.0 differing from Book#1.0 by containing a new attribute Multimedia and new operations Reserve and Release. At 120, it is noted that Commenteditem now relates Comment to Item. Finally, at 122, it is noted that LibraryService#2.0 replaces LibraryService#1.0 and differs from LibraryService#1.0 by changing the operation Comment and providing new operations Reserve and Release. Because the changes from Lib.1 to Lib.2 are to add types and operations to types and continue the same functionality as in Lib.1, Lib.2 is considered fully backward compatible. A similar analysis applies to the comparison of Lib.3 with respect to Lib.1 and those results are shown in box 112.

Lib.3, however, is incompatible with respect to Lib.2 as illustrated in box 114. At 130, it is noted that the type Issue from Lib.2 (Issue#1.0) is not present in Lib.3. That fact alone renders Lib.3 incompatible with respect to Lib.2 as clients designed to use the Issue functionality of Lib.2 will not find that same functionality in Lib.3. At 132, it is noted that Book#3.0 replaces Book#2.0 and that Book#3.0 lacks the Reserve and Release operations of Book#2.0. This difference again makes Lib.3 incompatible with respect to Lib.2.

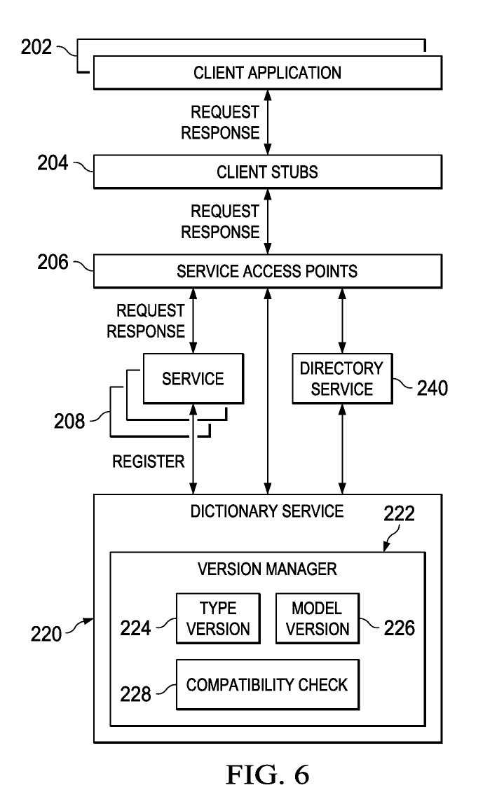

FIG. 6 provides an illustrative embodiment in which the techniques described herein can be used. FIG. 6 shows a Shared Services Platform (SSP) which melds SOA and model-driven architecture for describing Information Technology (IT) services. As shown, client applications 202 are able to access target services 208 through service access points (SAP) 206. Each client application 202 has an associated client stub 204 that facilitates the client application accessing a desired service 208. The services in the SSP are hosted at one or more SAPs 206 and interact through service models. The SAP is a proxy service that provides, among other things, message routing and validation capabilities. Through the SAP, a message from a client application 202 is routed to the target service and response messages from the service are routed back to the initiating client application. The SAP 206 includes a message validator 207.

Also shown, are a dictionary service 220 and a directory service 240, both of which are hosted on a computer. Each of the dictionary service 220 and the directory service 240 as well as the message validator 207 may be hosted on the same computer or separate computers.

The dictionary service 220 is the repository for all types and models in SSP and includes a version manager 222. A new service or new version of an existing service is registered with the version manager. The version manager 222 stores type version information 224 and model version information 226. The version manager 222 also includes a compatibility check module 228 which performs the comparison described above to check for backward compatibility of a new service model version against all previous versions of that same service.

The directory service 240 provides mechanisms for publishing and finding service descriptions, and is similar to a registry service. The distinction is that services are versioned, and that in addition to providing the normal discovery functions, the directory service 240 also facilitates obtaining compatibility information among different versions of a service. For this purpose, the directory service 240 interacts with the dictionary service 220.

For example, if a client application 202 requests a particular version of a service, the request is sent through the SAP 207 to the directory service 240. If the particular requested service version is available, the directory service 240 reports back to the client the location (i.e., Internet Protocol address) of the requested service. If the requested service version is not available, the directory service 240 requests the dictionary service 220 to identify the one or more versions of the target service that the dictionary service has determined to be compatible with the requested service version. The directory service 240 then reports the location of the compatible service version back to the client.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
receiving, by a processor, a description of a later version of a service model; and
determining, by said processor, backward compatibility of the description of the later version of the service model with a description of a previous version of the service model;
wherein each service model comprises one or more versionable types, each versionable type having an associated description.

2. The method of claim 1 wherein determining backward compatibility comprises performing, by said processor, a model-based compatibility assessment.

3. The method of claim 2 wherein performing the model-based compatibility assessment comprises determining, by said processor, whether a versionable type exists in the later version of the service model that does not exist in the previous version of the service model.

4. The method of claim 2 wherein performing the model-based compatibility assessment comprises determining, by said processor, whether a versionable type from the previous service model is missing from the later version of the service model.

5. The method of claim 2 wherein performing the model-based compatibility assessment comprises determining, by said processor, whether a versionable item from the previous model is present but updated in the later version of the service model.

6. The method of claim 1 wherein determining backward compatibility comprises performing, by said processor, a type-based compatibility assessment.

7. The method of claim 6 wherein performing the type-based compatibility assessment comprises determining, by said processor, whether a versionable item in the later version of the service model has been has an operation or attribute not present in the versionable item in the previous version of the service model.

8. The method of claim 6 wherein performing the type-based compatibility assessment comprises determining, by said processor, whether a versionable item in the later version of the service model has an operation or attribute that is different than for the versionable item in the previous version of the service model.

9. The method of claim 1 further comprising determining, by said processor, whether each versionable type in the previous version of the service model is present in the later version of the service model and flagging each such versionable type in the later version of the service model as being compatible or incompatible with that present in the previous version.

10. The method of claim 1 further comprising repeating, by said processor, said receiving and said determining for each of a plurality of previous versions of the service model to thereby determine whether said later version of the service is backward compatible with all of said previous versions.

11. A computer-readable storage medium (CRSM) storing software that, when executed by a processor, causes the processor to:
receive a description of a later version of a service and a description of a previous version of the service, each description comprising a versionable service model item and one or more versionable type items, each versionable service model item comprises a name and a version, and each versionable type item comprises a name, a version, and a description;
perform a service model-based compatibility assessment by determining whether a versionable type item in the later version of the service has been added or changed with regard to the previous version of the service; and
perform a versionable type-based compatibility assessment by comparing the descriptions between pairs of corresponding versionable type items among the later and previous versions of the service.

12. The CRSM of claim 11 wherein the software causing the processor to perform the service model-based compatibility assessment further comprises causing the processor to determine whether a versionable type item from the previous version of the service is missing from the later version of the service.

13. The CRSM of claim 11 wherein the description of each versionable type item is configured to contain attributes and methods, and wherein the software causing the processor to perform the versionable type-based compatibility assessment comprises causing the processor to determine whether an attribute or method has been changed among a pair of corresponding versionable type items.

14. The CRSM of claim 11 wherein the description of each versionable type item is configured to contain attributes and methods, and wherein the software causing the processor to perform the versionable type-based compatibility assessment comprises causing the processor to determine whether an attribute or method is included in the later version of the service compared to the previous version of the service.

15. The CRSM of claim 10 wherein said software, for each of a plurality of previous versions of the service model, causes the processor to determine to whether said later version of the service is backward compatible with all of said previous versions.

16. A computer system, comprising:
a processor;
storage accessible to said processor, said storage contains software that is executable by said processor;
wherein said software causes the processor to receive a description of a later version of a service model and determine backward compatibility of said description of the later version of the service model with a description of a previous version of said service model;
wherein each service model comprises one or more versionable types, each versionable type having an associated descriptions.

17. The computer system of claim 16 wherein the software causes the processor to determine, by said processor, whether a versionable type exists in the later version of the service model that does not exist in the previous version of the service model, whether a versionable type from the previous service model is missing from the later version of the service model, and whether a versionable item from the previous model is present but updated in the later version of the service model.

18. The computer system of claim 16 wherein the software causes the processor to determine, by said processor, whether a versionable item in the later version of the service model has been has an operation or attribute not present in or different from the versionable item in the previous version of the service model.

19. The computer system of claim 16 wherein the software causes the processor to determine whether each versionable type in the previous version of the service model is present in the later version of the service model and to flag each such versionable type in the later version of the service model as being compatible or incompatible with that present in the previous version.

20. The computer system of claim 16 wherein the software causes the processor to determine backward compatible of said later version of the service model with a plurality of previous versions of the service model.
